(19) United States
(12) Patent Application Publication
(10) Pub. No.: US 2026/0080304 A1
(43) Pub. Date: Mar. 19, 2026

(54) DATA QUALITY MODEL FOR DRIFT-RESISTANT INFERENCES

(71) Applicant: Capital One Services, LLC, McLean, VA (US)

(72) Inventors: Taylor TURNER, Richmond, VA (US); Samuel SHARPE, Somerville, MA (US)

(73) Assignee: Capital One Services, LLC, McLean, VA (US)

(21) Appl. No.: 18/889,292

(22) Filed: Sep. 18, 2024

(51) Int. Cl. G06N 20/00

(52) U.S. Cl. CPC G06N 20/00

(57) ABSTRACT

A method and related system for accounting for error drift in a machine learning model includes determining a first anomalous sequence in a first data stream by using a data quality model, providing the first data stream to a first decision model in lieu of a second decision model based on the first anomalous sequence, and determining a set of patterns based on the first anomalous sequence. The method further includes generating a set of synthetic sequences derived from the set of patterns, updating the data quality model based on the set of synthetic sequences.

### SUMMARY

The ability to process data streams representing various types of events is an important function for a wide-ranging of technical applications, ranging from cybersecurity to industrial automation. In many cases, incoming data can represent events that are most meaningfully interpreted in the context of a broader sequence. Such events may include sensor measurements, transactions, or messages. Machine learning models may be trained to provide inferences from a data stream or other sequential data. However, the accuracy of model-generated inferences may be severely damaged by data quality issues, such as mis-ordered sequences or incorrectly labeled events in a sequence. Furthermore, in contrast to errors apparent from a single event in an event sequence, errors that are only apparent in the context of a broader sequence may be significantly more difficult to detect or accommodate.

Some embodiments may account for such errors by detecting the presence of errors and synthesizing new sequences from those errors for training operations. Some embodiments may receive a data stream and use a data quality model to detect a first anomalous sequence in a first data stream. Some embodiments may then provide the first data stream to a first decision model in lieu of a second decision model based on the first anomalous sequence. In some embodiments, the first decision model may have fewer parameters or otherwise be a less-resource-intensive model that requires fewer computational resources than the second decision model but be less accurate. As described elsewhere, directing the data stream to the less-resource-intensive the detection of an anomalous sequence may conserve computing resource use without reducing accuracy due to the unpredictability of providing an anomalous sequence to the more complex second model. Such operations can dramatically increase the efficiency of computing operations, especially for high-throughput applications involving concurrent data streams and real-time or near-real-time use of decision models or other machine learning models.

Some embodiments may determine a set of patterns based on the first anomalous sequence, where the set of patterns may characterize or otherwise match with the anomalous sequence. Some embodiments may then determine whether the first anomalous sequence satisfies a set of drift criteria based on the set of patterns and a set of historic patterns. If the set of drift criteria is satisfied, some embodiments may synthesize a set of synthetic sequences based on the set of patterns. Some embodiments may then obtain an updated data quality model and an updated second decision model by training the data quality model and the second decision model based on the set of synthetic sequences. By training these models, some embodiments may then configure these models to provide more accurate classifications or more responsive decisions for future sequences similar to the first anomalous sequence. For example, some embodiments may obtain a second anomalous sequence of a second data stream by providing the second data stream to the updated data quality model to obtain a category for the second anomalous sequence. Some embodiments may then provide the second data stream to the second decision model in lieu of the first decision model based on the category for the second anomalous sequence. By using detected anomalous sequences to generate synthetic training data, some embodiments may provide more accurate and robust decision models that can account for drift in the errors or anomalies encountered in real-world data.

Various other aspects, features, and advantages of the invention will be apparent through the detailed description of the invention and the drawings attached hereto. It is also to be understood that both the foregoing general description and the following detailed description are examples and are not restrictive of the scope of the invention.

### BRIEF DESCRIPTION OF THE DRAWINGS

FIG. 1 shows an illustrative diagram for using a data quality model to accommodate error drift, in accordance with one or more embodiments.

FIG. 2 shows an illustrative diagram of an event sequence to accommodate error drift, in accordance with one or more embodiments.

FIG. 3 shows a flowchart of a process for using a data quality model to accommodate error drift, in accordance with one or more embodiments.

FIG. 4 shows a flowchart of a process for updating one or more machine learning models using synthetic data derived from errors, in accordance with one or more embodiments.

The technologies described herein will become more apparent to those skilled in the art by studying the detailed description in conjunction with the drawings. Embodiments of implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

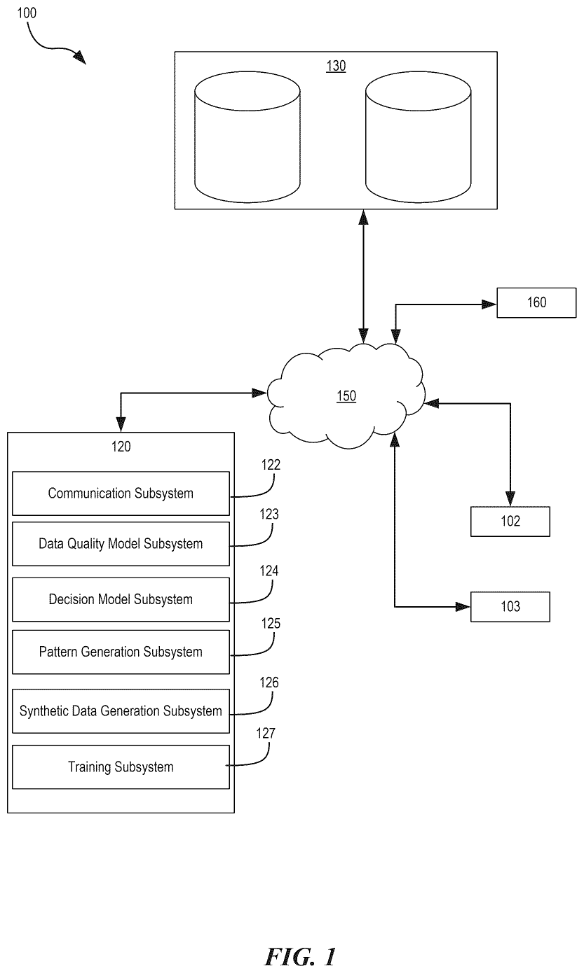

FIG. 1 shows an illustrative diagram for using a data quality model to accommodate error drift, in accordance with one or more embodiments. A system 100 includes a client device 102 in communication with a server 120 via a network 150. As will be described further in this disclosure, the server 120 may perform operations to determine which decision model to use, synthesize new data from an erroneous sequence for learning model training, or modify the cadence of scheduled training operations.

In some embodiments, the system 100 may intelligently select which decision model or other machine learning model to use based on whether an incoming data stream or other data sequence includes errors. For example, the system 100 may receive a first data stream using a data quality model to detect a first anomalous sequence in the first data stream. The system 100 may provide the first data stream to a first decision model in lieu of other decision models a category outputted by the data quality model. The data quality model may be or include a neural network model, random force model, or other machine learning model. The data quality of model may be trained to predict whether a sequence of events in a data stream or other data sequence a criteria includes one or more errors using a set of training sequences. Some embodiments may then use the output category or other result of the data quality model to determine patterns and retrain the data quality model or other models such that a later sequence may be provided to a decision model different from the first decision model.

In some embodiments, the system 100 may select which model to provide a received data stream or other obtained sequence of data for example, the system 100 may use a data quality model to predict the category “anomalous” for a first sub-sequence of a data stream. The system 100 may be configured to send data streams having a sub-sequence assigned an “anomalous” category to a simpler decision model instead of a complex decision model, where the simpler decision model may be simpler with respect to a lesser amount of model parameters and may require fewer computational resources to operate. After using the result of the data quality model to send data to the simpler decision model, some embodiments may then retrain more complex model to recognize sequences of events (“event sequences”) associated with the anomalous sub-sequence such that a later-obtained data stream having a similar anomalous sub-sequence will be processed by the more complex model.

In some embodiments, the system 100 may determine one or more patterns from a sequence and use the one or more patterns to update a data quality model, a decision model, or another model described in this disclosure. For example, after detecting an anomalous sequence in a data stream, some embodiments may use a pattern-recognition system to generate one or more patterns based on the anomalous sequence. A pattern may include symbols, phrases, strings, or other subsequences of characters that can represent a particular motif in a sequence. For example, some embodiments may detect an anomalous event sequence in a data stream and use a regular expression generator to generate a set of regular expression patterns from the anomalous event sequence. Some embodiments may then use this set of patterns to synthesize additional for training operations. For example, some embodiments may generate synthetic sequences based on a set of regular expression patterns by randomly populating fields in the regular expression patterns. Some embodiments may then update a set of training data with these synthetic sequences and use the set of training data to train a data quality model to recognize the previously unrecognized anomalous sequence, a decision model to provide an accurate prediction based on the anomalous sequence, or another machine learning model.

When synthesizing training data, some embodiments may obtain user feedback or other feedback indicating one or more categories or values to associate with the synthesized data. For example, some embodiments may obtain a user-provided message indicating that and anomalous sequence is associated with the outcome “fraud type A.” Some embodiments may then update training data to include the synthesized training data in association with the outcome “fraud type A.” Alternatively, some embodiments may generate synthesized training data and use the synthesized training data to train one or more machine learning models without user feedback. For example, some embodiments may assign a category “investigate” to a set of synthesized sequences by default and train a machine learning model to output “investigate.”

After performing one or more model training operations or other operations to update a model, some embodiments may change its response to a future sequence that includes one or more anomalous sequences. For example, after detecting a first anomalous event sequence in an event data stream using a data quality model that labels the anomalous event sequence with “unknown anomalous sequence,” the system 100 may direct the data stream containing the first anomalous event sequence to a first decision model instead of a second decision model. Some embodiments may then update the data quality model and the second decision model with synthesized data derived from the anomalous event sequence. Some embodiments may then receive a second data stream at a later time or monitor the same data stream and detect a second anomalous event sequence using the updated data quality model. Some embodiments may use the updated data quality model to assign the second category “known anomalous sequence” to the second anomalous event sequence and direct the data stream containing the second anomalous event sequence to the second decision model.

The client device 102 may include one of various types of computing devices, such as a laptop, a tablet, a desktop, etc. The client device 102 may send requests, responses, or other messages to the server 120 that may require communication with other computing devices or other electronic devices. Applications, services, or other operations may use data provided by the client device 102, the server 120, or a set of databases 130. The set of databases 130 may include various types of databases, such as SQL databases, no SQL databases, graph databases, etc. The server 120 may perform operations related to subsystems 122-127.

It should be noted that the computing devices described in this disclosure may be any type of computing device unless otherwise stated, including, but not limited to, a laptop computer, a tablet computer, a hand-held computer, and/or other computing equipment (e.g., a server), including “smart,” wireless, wearable, and/or mobile devices. Furthermore, the embodiments described in this disclosure may include an individual device that performs some or all the operations described in this disclosure. Alternatively, other embodiments may include multiple computing devices acting collectively to perform some or all the operations described in this disclosure.

In some embodiments, a communication subsystem 122 may obtain sequential data from a client device 102 or a third-party data system 160 to perform a set of operations. For example, the server 120 may obtain a first data stream of transactions from the client device 102 and a second data stream from the third-party data system 160. The communication subsystem 122 may further be used to collect data from multiple data sources to aggregate into one data stream. For example, the communication subsystem 122 may obtain both data from the client device 102 and the third-party data system 160 and aggregate the data into a single data stream.

In some embodiments, a data quality model subsystem 123 may control the use of one or more models described in this disclosure, such as machine learning models or statistical models. Unless otherwise stated, a machine learning model can include various types of learning models such as supervised learning models, reinforcement learning models, ensemble models, etc. The data quality model subsystem 123 may use a data quality model to predict whether an event sequence (e.g., an event sequence of a data stream) is anomalous or further categorize the event sequence with one or more categories indicating a type of anomaly associated with the event sequence. For example, the data quality model subsystem 123 may use a data quality model to classify a first sequence in a data stream provided by the client device 102 with the category “unexpected anomaly.” In response, the data quality model subsystem 123 may provide the data stream to a first decision model that may further categorize one or more sequences in the data stream or execute additional operations associated with the data stream or an entity associated with the data stream.

As used in this disclosure, a data quality model may refer to any machine learning model capable of categorizing data quality with respect to the existence of technical errors, malicious behavior, or other anomalous sequences. Such data quality issues can include mis-organized sequences (e.g., a third-party data service sends data much later than it should have, resulting in earlier-sent messages being received at a later time relative to later-sent messages), erroneous data (e.g., receiving data with incorrect dates, times, identifiers, or other values), missing data, or unsynchronized data. Sequences indicating malicious behavior may be indicated by the presence of events in separate geographic locations, transaction attempts that fail due to the inclusion of key data, etc.

In many cases, a machine learning data quality model may be trained to predict the correctness of a data sequence with far greater accuracy than the incorrectness of a data sequence. Thus, the output of a data quality model may be more trustworthy when labeling a sequence as non-anomalous than when labeling the sequence as anomalous. Similarly, a data quality model that is trained to categorize a sequence as exhibiting non-anomalous behavior, exhibiting expected anomalous behavior, or exhibiting unexpected anomalous behavior may be more accurate than a data quality model that is trained to specifically categorize a sequence with a label for the category. Thus, a downstream system may be used to process non-anomalous sequences or sequences having an expected anomaly differently than a sequence exhibiting an unexpected anomalous behavior.

In some embodiments, a decision model subsystem 124 may use various other models to perform subsequent operations. A decision model may include applications, services, functions, processes, or subsystems that output one or more classifications or values that effectuates a downstream operation. For example, a decision model may include a machine learning model that receives an event sequence as an input and outputs a category indicating fraud that causes a database management service to lock a record identified by one or more events of the event sequence. As another example, a decision model may include a transformer-based neural network model that receives, as an input, an event sequence and outputs a category indicating device failure, where such a category may then cause a cluster manager to re-allocate resources from a first set devices identified in the event sequences to a second set of devices. A decision model may be downstream with respect to a data quality model, such that data filtered or processed by the data quality model is then passed to one or more decision models. A decision model may be configured during a training operation to provide a set of categories for a sequence that will be used to determine one or more training sequences. For example, the set of categories may include specific classifications for types of sensor errors, errors related to third-party data source defects, anomalies indicating types of fraudulent behavior, anomalies indicating user mistakes, etc. In some embodiments, the categories provided by a decision model may cause one or more sensors to be shut down, one or more computing resources to be switched, etc. For example, the decision model subsystem 124 may use a decision model to determine, based on an anomalous sequence in a data stream provided by ten sensors, that a first group of edge computing devices is vulnerable to hardware failure and assign a category “failover” to the data stream. In response, one or more other subsystems may initiate a failover event that causes applications to migrate application operations from the first group of edge computing devices to a second group of edge computing devices.

In some embodiments, a pattern generation subsystem 125 may determine a set of patterns from a sequence indicated as anomalous. A pattern may include a sequence of regular expressions, a format-specific template having fields that can be populated by an application, etc. Some embodiments may use neural network models to generate regular expressions. For example, some embodiments may use a sequence-two-sequence model to generate a set of regular expressions based on an anomalous sequence extracted from a data stream. Alternatively, or additionally, the pattern generation subsystem 125 may use tools or applications that do not include machine learning models to determine a set of pattern sequences. For example, some embodiments may use a rules-based system to match patterns to segments of an anomalous sequence in order to generate one or more patterns that match the anomalous sequence or a segment of the anomalous sequence.

In some embodiments, a synthetic data generation subsystem 126 may generate one or more new sequences based on a set of patterns. For example, the synthetic data generation subsystem 126 may obtain a pattern “\hat{ }[A-Z][a-z]{2,4}\d{3}[!@#$%\hat{ }&*]{1,3}[0-9a-f]{5}$” and generate a first sequence “Qbcd123 #$%3a7f9” and a second sequence ‘Rabe789@2c4e0” to match the pattern using a random or pseudorandom process. Some embodiments may use more sophisticated methods to generate an event sequence from a pattern, such as retrieving entity identifiers from a set of records in a database storing entity names.

In some embodiments, a training subsystem 127 may update one or more machine learning models described in this disclosure, such as a data quality model used by the data quality model subsystem 123 or a decision model used by the decision model subsystem 124. The training subsystem 127 may first perform operations to determine whether a set of patterns derived from an anomalous sequence that satisfies a set of criteria. In some embodiments, the training subsystem 127 may combine the set of patterns with other patterns derived from other anomalous sequences to form a collection of pattern sets. The training subsystem 127 may then compare a collection of pattern sets to a pattern history.

In some embodiments, the training subsystem 127 may perform training in accordance with a training schedule, such as a schedule for a batch job. In some embodiments the training schedule may be modified to increase the rate of training based on factors related to one or more anomalous sequences, such as a detected change in the number or anomalous sequences detected in data streams, a detected change in the distribution of types of anomalous sequences detected in the data streams, a detection of one or more new patterns or an anomalous sequence, etc. For example, some embodiments may determine that a distribution of occurrences of a detected error types for anomalous sequences exceeds one or more thresholds or those types. In response, some embodiments may increase the frequency of one or more retraining operations for a machine learning model. Alternatively, or additionally, some embodiments may modify the training schedule of a machine learning model to reduce the time until the next training operation for the machine learning model in response to determining that an erroneous sequence has resulted in a new pattern. By letting the detection of anomalies or errors influence the model training schedule of a machine learning model, some embodiments may make the machine learning model more responsive to rapid changes in detected behaviors or sensor changes.

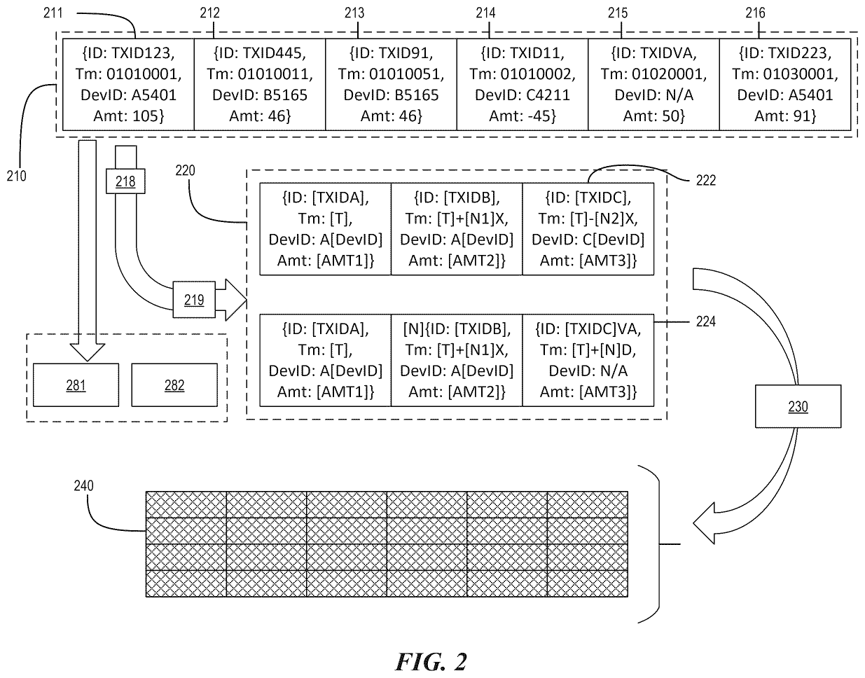

FIG. 2 shows an illustrative diagram of an event sequence to accommodate error drift, in accordance with one or more embodiments. A data stream 210 includes an event sequence of event blocks 211-216. Each event block may represent a discrete event, where such an event may change to a record, such as a database transaction affecting the record. Some embodiments may analyze the data stream 210 with a data quality model 218, where the data quality model 218 may categorize the event sequence of event blocks 211-216 with a category indicating that the event sequence represented by event blocks 211-216 exhibit an unknown anomaly. Some embodiments may then direct data from the data stream 210 to a first decision model 281 in lieu of a second decision model 282 based on a determination that the event blocks 211-216 exhibit an unknown anomaly. In some embodiments, the first decision model 281 may be more accurate in comparison to the second decision model 282 when processing unknown anomalous sequences. In contrast, the first decision model 281 may be less accurate in comparison to the second decision model 282.

Some embodiments may provide the event sequence of event blocks 211-216 to a pattern generator 219 to generate one or more patterns, such as a first pattern 222 or a second pattern 224. Some embodiments may then use the patterns as an input for a synthetic data generator 230. The synthetic data generator 230 may populate elements of the pattern set 220 with randomly generated values and create a set of synthetic sequences 240. Some embodiments may then use the set of synthetic sequences to retrain the data quality model 218, the second decision model 282, or another model described in this disclosure.

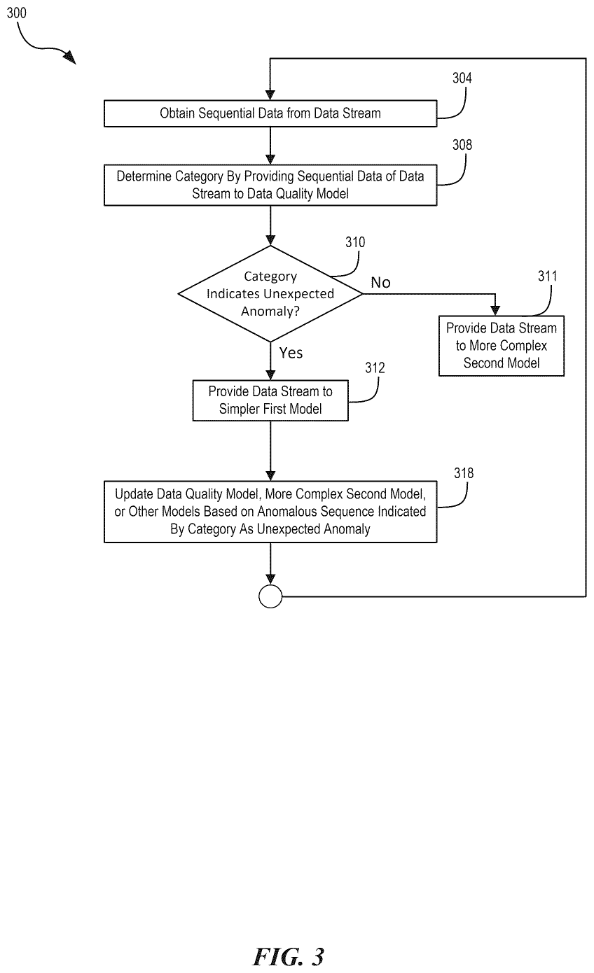

FIG. 3 shows a flowchart of a process for using a data quality model to accommodate error drift, in accordance with one or more embodiments. Some embodiments may obtain sequential data from a data stream, as indicated by block 304. Some embodiments may receive data sequences from one or more data sources via one or more types of communication media. Some embodiments may receive sequences from a network socket, an application program interface (API), a message queue (e.g., Apache Kafka, Amazon SQS, etc.), streaming protocols (e.g., real-time messaging protocols, message queuing telemetry transport, etc.), hardware interfaces providing readings from sensors or other hardware devices, etc. for example, some embodiments may receive a data stream at an API endpoint from a set of data sources indicating transactions for a financial account, where the sequence of data in the data stream may include discrete blocks of data, each walk represents a separate transaction involving an account record.

Some embodiments may determine a category by providing the sequential data of the data stream to a data quality model, as indicated by block 308. For example, some embodiments may provide a data stream to a data quality model by providing all data in the data stream to the most recent element of the data stream to the data quality model. Alternatively, or additionally, some embodiments may provide data that is within a specified duration or data that is of a specified length to the data quality model. For example, some embodiments may extract the most recent fifty events in a sequence of events (e.g., a sequence obtained from a data stream) and provide the most recent fifty events to a machine learning model that has been trained to output one or more categories associated with the most recent fifty events.

Some embodiments may chunk the data stream or another input sequence to generate abridged versions of the data stream or other input sequence. For example, after receiving a data stream comprising a sequence of 1,000 discrete event blocks, some embodiments may chunk the 1,000 discrete event blocks into a set of chunks that include fifty event blocks, where the event blocks may overlap. Alternatively, some embodiments may generate non-overlapping chunks. Some embodiments may then provide the set of chunks to a data quality model and perform other operations described in this disclosure.

The data quality model may include one or more machine learning models, such as a transformer-based neural network model. The data quality model may be trained to classify a sequence as non-anomalous or anomalous, where a downstream model may then be used to classify an anomalous sequence. By using a data quality model that detects whether a sequence is exhibiting expected behavior or not exhibiting expected behavior instead of using a more sophisticated categorization model, some embodiments may more easily use the data quality model in real-time applications or high data throughput applications. In some embodiments, a data quality model may output additional categories instead of simply two categories.

Some embodiments may use a data quality model having a linear order or pseudo-linear order. For example, some embodiments may use a data quality model that includes a linear transformer model. Furthermore, some embodiments may configure a data quality model to be more efficient and work in high-throughput environments. For example, a data quality model may include a transformer model. Some embodiments may determine a throughput of a set of data streams and reduce a window size of the transformer model based on the throughput value. For example, some embodiments may reduce a window size to the most recent 20 event records for an event sequence if a throughput for a set of data streams exceeds a throughput threshold (e.g., a maximum bits per second). Alternatively, some embodiments may determine a window size based on a function that is an inverse correlation or other negative correlation with the throughput such that a greater throughput results in a smaller window size. Alternatively, or additionally, some embodiments may modify a window size based on a messaging rate. For example, some embodiments may reduce a window size to the most recent 20 event records for an event sequence if a message rate for a set of data streams exceeds a message rate threshold (e.g., a maximum number of messages per second). Alternatively, some embodiments may determine a window size based on a function that is an inverse correlation or other negative correlation with the message rate such that a greater message rate results in a smaller window size.

Some embodiments may determine whether the category provided by the data quality model indicates an unexpected anomaly, as indicated by block 310. A category indicating an unexpected anomaly in a sequence (e.g., a sequence in a data stream) may trigger downstream operations to retrain the data quality model, downstream decision model, or another machine learning model.

In some embodiments, a sequence generation model may transform a known anomalous sequence into non-anomalous sequence. For example, some embodiments may use a data quality model to detect that the event subsequence “[p1: seq1, p2: seq4]. [p1: FFq1, p2: FFq4]” of the event sequence “[p1: BB, p2: “blue”], [p1: seq1, p2: seq4]. [p1: FFq1, p2: FFq4], [p1: AA, p2: “red”]” is anomalous. Some embodiments may then use the sequence generation model to convert the event subsequence “[p1: seq1, p2: seq4]. [p1: FFq1, p2: FFq4]” into the corrected event subsequence “[p1: FFq1, p2: FFq4], [p1: seq1, p2: seq4]. ” The sequence generation model may include a neural network model (e.g., a seq2seq model) or another machine learning model. Some embodiments may then splice or otherwise re-integrate the corrected sub-sequence into event sequence to form a corrected event sequence event sequence “[p1: BB, p2: “blue”], [p1: FFq1, p2: FFq4], [p1: seq1, p2: seq4], [p1: AA, p2: “red”]. ” By converting an erroneous sequence or other anomalous sequence into a corrected sequence and then re-integrating the corrected sequence into the data stream or other parent sequence, some embodiments may increase the accuracy or effectiveness of downstream operations.

If the data quality model outputs a category that indicates an unexpected anomaly, operations of the process 300 may proceed to operations described by block 312. Otherwise, operations of the process 300 may proceed to operations described by block 311. For example, the data quality model may output a category indicating that a sequence of data in a data stream shows an anomaly or shows anomalies that are known. In response, operations of the process 300 may proceed to operations described by block 311.

Some embodiments may provide the data stream to a more complex second model, as indicated by block 311. In some embodiments, a computer system may be provided to the more complex second model instead of a simpler first model. The second model may be more complex with respect to architecture or a number of parameters in contrast to a first model (e.g., both the first and second models may be neural networks, but the second model may include more layers, more neurons per layer, or include additional complexities such as a gate component or attention layer in the more complex model that is absent in a simpler model). For example, a second model may include a deep neural network model having three or more hidden layers, whereas the first model may be a simple neural network having only one hidden layer. In some embodiments, the simpler first model may be a distilled version of the more complex second model. For example, some embodiments may first use training data to generate a set of outcome probabilities using a more complex second model. Some embodiments may then use the same training data to train a simpler first model to match (within a tolerance threshold) the set of outcome probabilities. Furthermore, in cases where the complex second model is updated by training operations such as those described for block 318 or process 400, some embodiments may re-distill a simpler first model. Alternatively, the simpler first model may be completely configured independently of the second model.

As described elsewhere in this disclosure, some embodiments may update the second model based on synthetic sequences derived from a first anomalous sequence detected by a data quality model. After being updated, the second model may be able to provide more accurate categorizations for future anomalous sequences that are similar to the first anomalous sequence and be provided with the same data stream at a later time or a new data stream. In some embodiments, the data quality model may detect additional anomalies. If a count of anomalous sequences in the same data stream at a later time or the new data stream exceeds an error count threshold, some embodiments may redirect additional inputs derived from the data stream provided to the second model back to the first model. Such a redirection may account for unexpected increases in errors, fraudulent behavior, or other unexpected phenomena indicating a form of error drift that may have gone unaccounted for after the retraining of the more complex second model.

Some embodiments may provide a data stream to a simpler first model, as indicated by block 312. The first model may be a first decision model that includes one or more machine learning models, where the first model may be selected from a plurality of models that includes at least a second model. The first model may be simpler than the second model or require fewer computational resources than other possible models that could have been selected to process a sequence in a data stream. In many cases, the first model may have fewer parameters than the other possible models, such as a second model that processed the data stream. For example, the first model may be a simple linear regression model having ten parameters and the second model may be a neural network model having one hundred parameters. A system that is configured to select a simpler first model in lieu of a more complex second model for processing data having anomalous sequences may be more efficient because such a configuration can conserve computational resources. Avoiding the use of a more processor-intensive or more memory-intensive model that might be poorly adapted to handle the anomalous sequence can provide significant benefits to high-throughput applications.

The set of possible models that can be selected to process data from a data stream or other sequential data may be based on the same architecture. For example, a computer system may select a first decision model from a plurality of decision models that also includes a second decision model and a third decision model based on a determination that a sequence in the data stream is categorized as “anomalous.” The computer system may then provide data stream data to the first decision model in lieu of the second or third decision models. In some embodiments, the first model, second model, and third model may each be transformer neural network models such that the models differ with respect to parameter size. For example, the first model may have fewer parameters than the second model, and the second model may have fewer parameters than the third model. Alternatively, the models may have different architecture from each other or even be based on completely different algorithms. For example, a first model may be based on logistic regression model or an Autoregressive Integrated Moving Average (ARIMA) model, and a second model may be based on a transformer neural network model.

The parameters of a machine learning model may include learnable parameters, such as weights or biases of a neural network. The parameters may include model-specific parameters, such as recurrent state parameters (e.g., LSTM gates) of a recurrent neural network, attention weights of a transformer-based neural network, batch normalization parameters of a batch normalization layer, leaf values of a decision tree model, coefficients of a linear regression model, etc. When training or otherwise updating a model, some embodiments may perform training operations that updates one or more learnable parameters of the model. For example, some embodiments train a transformer neural network model used by a data quality model by updating the attention eights of the transformer neural network model.

Some embodiments may filter a data stream or other input sequence to remove anomalous data, such as an anomalous sequence forming a segment of the data stream or other input sequence. For example, some embodiments may detect an anomalous sequence “[p1: seq1, p2: seq4]. [p1: FFq1, p2: FFq4]” in a data stream having the sequence “[p1: BB, p2: “blue”], [p1: seq1, p2: seq4]. [p1: FFq1, p2: FFq4], [p1: AA, p2: “red”]” and remove the anomalous sequence to generate a modified data stream “[p1: BB, p2: “blue”], [p1: AA, p2: “red”]. ” Some embodiments may then provide the modified data stream to the first model for downstream processing.

Some embodiments may update the data quality model, second model, or another model described in this disclosure based on the anomalous sequence indicated by the category as an unexpected anomaly, as indicated by block 318. Updating a model may include retraining the model on a training data set that includes the anomalous sequence or synthesized sequences derived from the anomalous sequence. For example, some embodiments may retrain a transformer-based neural network model used as a data quality model with a training dataset that includes synthesized data generated from a set of patterns, where the set of patterns is generated from an anomalous sequence. Furthermore, some embodiments may perform some or all of the operations described for a process 400 when training a model, as described further below.

Some embodiments may update a data quality model by training the model such that the anomalous sequence or sequences similar to the anomalous sequence will be classified by the data quality model as a known anomaly (e.g., by using a label titled “recognized anomaly”). Similarly, some embodiments may update a downstream decision model based on synthesized data derived from an anomalous sequence to recognize the anomalous sequence or sequences similar to the anomalous sequence. By updating a data quality model or downstream decision model, some embodiments may adapt to future encounters with anomalies similar to or the same as the anomalous sequence.

When updating a model based on an anomalous sequence, some embodiments may combine the anomalous sequence or data synthesized based on the anomalous sequence with other data obtained from other data streams or other data sources. For example, a computer system may generate ten synthesized sequences for each of five anomalous sequences obtained from five data streams to produce a collection of fifty synthesized sequences. The computer system may then use the fifty synthesized sequences to train a machine learning model used as a data quality model, such that the data quality model will classify the five anomalous sequences or other sequences similar to the five anomalous sequences as “known anomalies.” Training a data quality model or a decision model may include updating the weights, biases, or attention weights of the data quality model or decision model. When training a data quality model, some embodiments may use user-provided labels for the anomaly and associate synthesized sequence with the same user-provided labels. Alternatively, some embodiments may use machine-generated labels for the anomaly. For example, some embodiments may assign a machine-generated label to an anomalous sequence based on date of creation or date of detection, a general anomaly type, and an outcome to an anomalous sequence. Some embodiments may then assign the same label to a set of synthesized data generated from the anomalous sequence and train a data quality model to associate such sequences with the machine-generated label.

After the data quality model, decision model, or other models are updated, operations of the process 300 may return to operations described for block 304. As a result of the retraining operations described above, in future encounter with an anomalous sequence in the same data stream or a different data stream may be treated differently that had the machine learning models not been trained. For example, a computer system may use a first data quality model to classify a sequence “[[prop1: aB01, prop2: 21], [prop1: bb04, prop2: −10], [prop1: bb04, prop2: 50]]” in a first data stream as an unknown anomalous sequence. In response, the computer system may perform operations described in this disclosure to determine a set of patterns that match this anomalous sequence and synthesize a set of synthetic sequences based on the third of patterns. Some embodiments may then update a data quality model and a more complex second decision model to form an updated data quality model and an updated more complex second decision model (“updated second decision model” or “updated complex decision model”) by retraining these models with the set of synthetic sequences.

In some embodiments, after a retraining operation, a computer system may then receive additional data in a second data stream at a later time and encounter a second event sequence “[[prop1: qB01, prop2: 31], [prop1: bb04, prop2:-15], [prop1: bB01, prop2: 55]]. ” The computer system may use the updated data quality model to categorize the second sequence as a second anomalous sequence of the second data stream (e.g., assign the second event sequence with the label “known anomaly”). As a response to categorizing the second event sequence with a label indicating that the event sequence includes a known anomaly, the computer system may send the additional data in the data stream to the updated second decision model. For example, the additional data may include the second anomalous sequence of the second data stream to the updated second decision model and, in response, receive an output category “fraud” for the second anomalous sequence. As a result of this output category, some embodiments may stop all transactions related to a record associated with the second data stream.

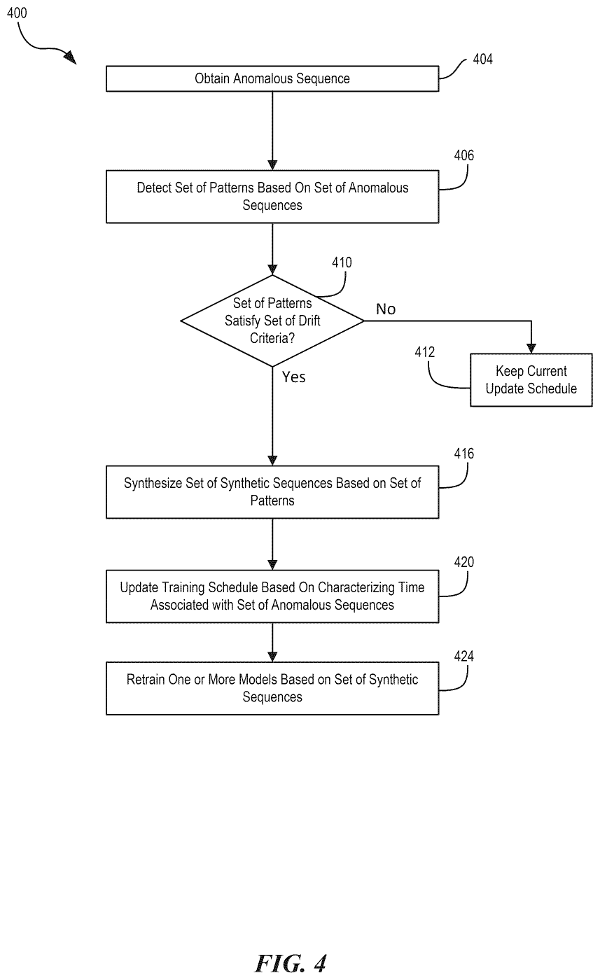

FIG. 4 shows a flowchart of a process for updating one or more machine learning models using synthetic data derived from errors, in accordance with one or more embodiments. Some embodiments may obtain anomalous sequence, as indicated by block 404. As described elsewhere this disclosure, an anomalous sequence may be extracted from a portion of a data stream being received in real time. Alternatively, the anomalous sequence may be extracted from historical data associated with a user, account, a set of accounts, a set of sensors, etc.

Some embodiments may detect a set of patterns based on the set of anomalous sequences, as indicated by block 406. For example, some embodiments may detect a text portion structured in a format that is recognizable by an application capable of interpreting regular expression patterns and replace the text portion with a machine-generated set of characters that matches the regular expression pattern represented by the text portion. A pattern may be written in a person public or may be written as one or more expressions interpretable by a program code interpreter. For example, some embodiments may convert characters or strings in a data sequence with regular expressions such that a name may be represented by the regular expression pattern “\hat{ }a.” Alternatively, or additionally, some embodiments may detect a field of a pattern and populated the field with a value associated with that field. For example, some embodiments may detect a field of a template that is associated with a label “three characters” and, in response, populate the field with three characters.

In some embodiments, entity names, entity identifiers, or other values associated with entities may be detected in a sequence. For example, if an event sequence indicating a series of events associated with a user is obtained by a computer system, the computer system may query an entity database to detect one or more entities identified in the event sequence. For example, some embodiments may obtain an event sequence that includes the element “[transmitter: ‘device15’, database: “db215”]”, where the event sequence is associated with a user identifier “usr1.” In response, some embodiments may access a database with user identifier “usr1” to retrieve a record indicating that “device15” is a known entity. After recognizing that “device15” is an entity identifier, the computer system may then generate a pattern that includes the entity identifier “device15.” For example, the computer system may generate a pattern that includes regular expression pattern, such as “[transmitter: ‘device15’, database: “\hat{ }db\d{3}$”].” Furthermore, the computer system may generate a plurality of patterns that include the entity identifier.

Some embodiments may determine whether the set of patterns satisfy a set of drift criteria, as indicated by block 410. The set of drift criteria may include various types of criteria that indicate whether detected anomalies are new types of anomalies, are different in distribution of anomaly types with respect to historical distributions of anomaly types or are sufficiently similar to previously detected anomalies. The set of drift criteria used to trigger model update operations may include a criterion that received sequences indicate one or more new patterns, a criterion that a distribution of patterns exceeds one or more thresholds, a criterion that a rate of detected anomalies exceeds one or more thresholds, etc. Furthermore, some embodiments may use the same set of criteria described for block 310 as for block 410. Alternatively, in some embodiments, the set of criteria described for block 310 may differ from those of block 410.

In some embodiments, a set of drift criteria may be based on a characterizing time of a sequence (e.g., a starting time of the sequence, an ending time of the sequence, a midpoint time of the sequence, some time between the starting and ending times of the sequence). For example, a computer system may determine a time difference between a characterizing time of an anomalous sequence and a characterizing time of a previous training operation of a model. For example, a previous training operation may include a most recent training operation of a data quality model, a decision model, another model described in this disclosure. The computer system may then determine that the time difference is less than a duration threshold based on a scheduled training time. For example, the duration threshold may be proportionally correlated with the time between two starting times for a pair of previous training operations for a decision model. Alternatively, the duration threshold may be a predefined value, such as a duration less or equal to one hour, a duration less or equal to 12 hours, a duration less or equal to one day, a duration less or equal to one week, a duration less or equal to one month, etc.

Some embodiments may determine that the set of drift criteria is satisfied if the time difference is less than the duration threshold. For example, a computer system may determine a time difference between the ending time of an anomalous sequence and a starting time of a most recent training operation for a decision model. The computer system may then determine that the time difference is less than a duration threshold equal to 6 hours and, in response, determine that the set of drift criteria is satisfied. Alternatively, or additionally, some embodiments may detect an aggregated collection of anomalous sequences and determine a respective time difference for each respective sequence of the aggregated collection of sequences. Some embodiments may then determine whether a mean average (or another measure of central tendency) for the time differences satisfy a duration threshold and, if so (e.g., by being less than duration threshold), determine that the set of drift criteria is satisfied. By comparing time differences to duration thresholds, some embodiments may detect whether unexpected anomalies are occurring too frequently and increasing the rate of retraining to compensate for the increase in frequency.

In some embodiments, detecting a new pattern may act as a trigger to retrain a machine learning model or increase retraining frequency for the machine learning model. For example, after determining that a set of patterns derived from an anomalous sequence includes a unique pattern not present in a set of historic patterns, a computer system may determine that the set of drift criteria is satisfied. The computer system may then proceed to operations described by block 416 or other operations described in this disclosure to synthesize data for training operations and then retrain one or more machine learning models using this synthesized data. Alternatively, or additionally, some embodiments may modify the scheduled training time to reduce the time before the next retraining operation is scheduled to begin. For example, some embodiments may initially use a training schedule that causes model retraining every 24 hours. However, after receiving an anomalous sequence and determining that the anomalous sequence includes a unique pattern, a computer system may modify the training schedule by changing the scheduled training time to occur within two hours.

Some embodiments may combine the most recently detected anomalous sequences with other anomalous sequences to form an aggregated collection of patterns and determine that a set of drift criteria is satisfied based on the aggregated collection. For example, a computer system may implement a criterion to initiate retraining or reduce the time until the next scheduled training time based on receiving a threshold number of new patterns. After detecting one unique pattern from a first anomalous sequence, the computer system may modify a retraining schedule for one or more machine learning models. However, after deriving a plurality of unique patterns from a plurality of data streams or other received data sequences and collecting the unique patterns into an aggregated collection of patterns, a computer system may determine that a count of this plurality of patterns satisfies a minimum threshold. In response, the computer system either initiates a model retraining operation or reduces the time until the next model retraining operation.

In some embodiments, a computer system may compare a set of patterns derived from an anomalous sequence with a set of historic patterns to determine whether to trigger operations to update one or more machine learning models. For example, some embodiments may derive multiple sets of patterns from multiple anomalous sequences collected over multiple data streams and collect the multiple sets of patterns into an aggregated collection of patterns. In some embodiments, individual patterns within a pattern set of the multiple sets of patterns may be the same with respect to a different pattern set of the multiple sets of patterns. Some embodiments may then count the number of patterns to determine a set of pattern counts and compare this distribution of patterns to a pattern distribution derived from a set of historic data stream patterns. For example, some embodiments may detect one hundred occurrences of patterns from a set of anomalous sequences and, in response, determine a pattern distribution defined as 30 occurrences of a first pattern, 40 occurrences of a second pattern, 20 occurrences of a third pattern, and 10 occurrences of a fourth pattern from the aggregated collection of patterns. Some embodiments may compare this distribution of the aggregated collection of patterns to a historic pattern distribution, where the historic pattern distribution may be determined by using a set of historic patterns. For example, an exemplary historic pattern distribution may be 35% of the first pattern, 35% of the second pattern, 22% of the third pattern, and 18% of the fourth pattern and determine whether the distribution satisfies a set of pattern distribution thresholds representing a fitness criterion. For example, some embodiments may use a goodness-of-fit test (e.g., a Kolmogorov-Smirnov test, a Chi-Square goodness of fit test) with a predefined threshold parameter to determine whether the observed pattern distribution sufficiently satisfies a pattern distribution fitness threshold. Some embodiments may determine that the set of patterns satisfy the set of drift criteria if the goodness-of-fit test indicates that an observed distribution of patterns fails to fit a historic distribution. For example, a computer system may apply a Chi-Square goodness of fit test and determine that a p-value of a fitness between the set of pattern counts based on a received set of anomalous sequences fails a pattern distribution fitness threshold equal to 0.05 (e.g., the significance value is set to .05). In response, the computer system may determine that a set of patterns derived from a set of anomalous sequences satisfy the set of drift criteria.

Some embodiments may also reduce retraining frequency if it seems that a distribution of patterns is stable. For example, after determining a set of patterns with a pattern generator based on a sequence, some embodiments may increase the respective count value for each respective pattern in the set of patterns. Some embodiments may then apply a fitness test, such as a Chi-Square goodness of fit test and increase the time until a next scheduled training time if the set of pattern counts satisfies a fitness test threshold of the fitness test (e.g., a pre-defined significance value).

In some embodiments, new patterns that are not one of the patterns explicitly presented in the historic pattern distribution may be grouped in an unobserved category. For example, some embodiments may detect a single occurrence of fifth pattern and two occurrences of a sixth pattern and then group the occurrences of the fifth and sixth patterns as three occurrences of new patterns not encountered in the historic pattern distribution, where the historic pattern distribution may include a distribution value for unencountered patterns.

Based on a determination that the set of drift criteria is satisfied, operations of the flowchart 410 may proceed to operations described for block 416. Otherwise, operations of the flowchart 410 may proceed to operations described for block 412.

Some embodiments may keep a current update schedule, as indicated by block 412. A determination that the set of drift criteria is not satisfied may indicate the there is insufficient reason to retrain a model or change the training schedule for a model. Some embodiments may then proceed to return to operations described for the process 300 or other operations described in this disclosure.

Some embodiments may synthesize a set of synthetic sequences based on the set of patterns, as indicated by block 416. As described elsewhere in this disclosure, a pattern may be used as a template to generate new sequences. For example, a pattern that includes regular expressions may be used as an input for a sequence generation algorithm that populates elements of a new data sequence with elements generated from a matching with the regular expression portions of the pattern. Alternatively, or additionally, specified values in a pattern may be the same in the synthesized data. For example, if a pattern includes an entity identifier, a synthetic sequence generated from that pattern may include the same entity identifier. It should also be understood that a pattern may include other combinations of characters, symbols, strings, or other values that are interpretable to a custom application for the purposes of populating elements of a sequence.

Some embodiments may update a training schedule based on a characterizing time associated with the set of anomalous sequences, as indicated by block 420. As described elsewhere in this disclosure, some embodiments may perform periodic retraining based on a schedule. For example, some embodiments may retrieve a Cron job file and use the Cron job file to determine the times at which to initiate retraining operations for a data quality model, a decision model, or another machine learning model described in this disclosure. A schedule to increase the frequency of retraining operations based on a determination that the set of drift criteria is satisfied or based on other criteria. For example, some embodiments may modify a training schedule based on a determination that a type of anomalous sequence is being encountered too frequently.

When modifying a schedule, some embodiments may replace a job file used to control the timing of one or more batch jobs. Alternatively, or additionally, some embodiments may use more sophisticated scheduling systems and modify the parameters of the files controlling those scheduling systems. For example, some embodiments may modify a JSON file used to configure the batch jobs scheduled by the Apache Airflow platform.

Some embodiments may retrain one or more models based on the set of synthetic sequences, as indicated by block 424. Some embodiments may train models at times defined by a scheduling system. For example, some embodiments may retrieve a JSON file that schedules a training operation for a data quality model at 2 AM. Some embodiments may then perform this training operation at 2 AM. Alternatively, some embodiments may perform one or more training operations without the training operation being scheduled by a scheduling application.

When retraining a model, some embodiments may combine the synthetic data with a set of historic sequences to form a full set of training data. Alternatively, some embodiments may use only the synthetic data to train a machine learning model. For example, some embodiments may use the new sequences to partially train only one or two layers of a multilayered neural network model used as a decision model. By restricting training data to the synthetic sequences, some embodiments may protect the privacy of users and reduce the total amount of computing resources needed to train one or more models.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

It should be noted that the features and limitations described in any one embodiment may be applied to any other embodiment herein, and a flowchart or examples relating to one embodiment may be combined with any other embodiment in a suitable manner, done in different orders, or done in parallel. Furthermore, not all operations of a flowchart need to be performed. In addition, the systems and methods described herein may be performed in real time. It should also be noted that the systems and/or methods described above may be applied to, or used in accordance with, other systems and/or methods.

As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety (i.e., the entire portion), of a given item (e.g., data) unless the context clearly dictates otherwise. Furthermore, a “set” may refer to a singular form or a plural form, such that a “set of items” may refer to one item or a plurality of items.

In some embodiments, the operations described in this disclosure may be implemented in a set of processing devices (e.g., a digital processor, an analog processor, a digital circuit designed to process information, an analog circuit designed to process information, a state machine, and/or other mechanisms for electronically processing information). The processing devices may include one or more devices executing some or all of the operations of the methods in response to instructions stored electronically on one or more non-transitory, machine-readable media (e.g., a set of machine-readable storage media), such as an electronic storage medium. Furthermore, the use of the term “media” may include a single medium or combination of multiple media, such as a first medium and a second medium. A set of non-transitory, machine-readable media storing instructions may include instructions included on a single medium or instructions distributed across multiple media. The processing devices may include one or more devices configured through hardware, firmware, and/or software to be specifically designed for the execution of one or more of the operations of the methods.

In some embodiments, the various computer systems and subsystems illustrated in FIG. 1 or FIG. 2 may include one or more computing devices that are programmed to perform the functions described herein. The computing devices may include one or more electronic storages (e.g., a set of databases accessible to one or more applications depicted in the system 100), one or more physical processors programmed with one or more computer program instructions, and/or other components. For example, the set of databases may include a relational database such as a PostgreSQL™ database or MySQL database. Alternatively, or additionally, the set of databases or other electronic storage used in this disclosure may include a non-relational database, such as a Cassandra™ database, MongoDB™ database, Redis database, Neo4j™ database, Amazon Neptune™ database, etc.

The computing devices may include communication lines or ports to enable the exchange of information with a set of networks (e.g., a network used by the system 100) or other computing platforms via wired or wireless techniques. The network may include the internet, a mobile phone network, a mobile voice or data network (e.g., a 5G or Long-Term Evolution (LTE) network), a cable network, a public switched telephone network, or other types of communications networks or combination of communications networks. A network described by devices or systems described in this disclosure may include one or more communications paths, such as Ethernet, a satellite path, a fiber-optic path, a cable path, a path that supports internet communications (e.g., IPTV), free-space connections (e.g., for broadcast or other wireless signals), Wi-Fi, Bluetooth, near field communication, or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Each of these devices described in this disclosure may also include electronic storages. The electronic storages may include non-transitory storage media that electronically stores information. The storage media of the electronic storages may include one or both of (i) system storage that is provided integrally (e.g., substantially non-removable) with servers or client computing devices, or (ii) removable storage that is removably connectable to the servers or client computing devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). An electronic storage may store software algorithms, information determined by the processors, information obtained from servers, information obtained from client computing devices, or other information that enables the functionality as described herein.

The processors may be programmed to provide information processing capabilities in the computing devices. As such, the processors may include one or more of a digital processor, an analog processor, a digital circuit designed to process information, an analog circuit designed to process information, a state machine, and/or other mechanisms for electronically processing information. In some embodiments, the processors may include a plurality of processing units. These processing units may be physically located within the same device, or the processors may represent the processing functionality of a plurality of devices operating in coordination. The processors may be programmed to execute computer program instructions to perform functions described herein of subsystems described in this disclosure or other subsystems. The processors may be programmed to execute computer program instructions by software; hardware; firmware; some combination of software, hardware, or firmware; and/or other mechanisms for configuring processing capabilities on the processors.

It should be appreciated that the description of the functionality provided by the different subsystems described herein is for illustrative purposes, and is not intended to be limiting, as any of the subsystems described in this disclosure may provide more or less functionality than is described. For example, one or more of subsystems described in this disclosure may be eliminated, and some or all of its functionality may be provided by other ones of subsystems described in this disclosure. As another example, additional subsystems may be programmed to perform some or all of the functionality attributed herein to one of the subsystems described in this disclosure.

With respect to the components of computing devices described in this disclosure, each of these devices may receive content and data via input/output (I/O) paths. Each of these devices may also include processors and/or control circuitry to send and receive commands, requests, and other suitable data using the I/O paths. The control circuitry may comprise any suitable processing, storage, and/or I/O circuitry. Further, some or all of the computing devices described in this disclosure may include a user input interface and/or user output interface (e.g., a display) for use in receiving and displaying data. In some embodiments, a display such as a touchscreen may also act as a user input interface. It should be noted that in some embodiments, one or more devices described in this disclosure may have neither user input interface nor displays and may instead receive and display content using another device (e.g., a dedicated display device such as a computer screen and/or a dedicated input device such as a remote control, mouse, voice input, etc.). Additionally, one or more of the devices described in this disclosure may run an application (or another suitable program) that performs one or more operations described in this disclosure.

Although the present invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the scope of the appended claims. For example, it is to be understood that the present invention contemplates that, to the extent possible, one or more features of any embodiment may be combined with one or more features of any other embodiment.

As used throughout this application, the word “may” is used in a permissive sense (i.e., meaning having the potential to), rather than the mandatory sense (i.e., meaning must). The words “include,” “including,” “includes,” and the like mean including, but not limited to. As used throughout this application, the singular forms “a,” “an,” and “the” include plural referents unless the context clearly indicates otherwise. Thus, for example, reference to “an element” or “the element” includes a combination of two or more elements, notwithstanding the use of other terms and phrases for one or more elements, such as “one or more.” The term “or” is non-exclusive (i.e., encompassing both “and” and “or”), unless the context clearly indicates otherwise. Terms describing conditional relationships (e.g., “in response to X, Y,” “upon X, Y,” “if X, Y,” “when X, Y,” and the like) encompass causal relationships in which the antecedent is a necessary causal condition, the antecedent is a sufficient causal condition, or the antecedent is a contributory causal condition of the consequent (e.g., “state X occurs upon condition Y obtaining” is generic to “X occurs solely upon Y” and “X occurs upon Y and Z”). Such conditional relationships are not limited to consequences that instantly follow the antecedent obtaining, as some consequences may be delayed, and in conditional statements, antecedents are connected to their consequents (e.g., the antecedent is relevant to the likelihood of the consequent occurring). Statements in which a plurality of attributes or functions are mapped to a plurality of objects (e.g., a set of processors performing steps/operations A, B, C, and D) encompass all such attributes or functions being mapped to all such objects and subsets of the attributes or functions being mapped to subsets of the attributes or functions (e.g., both/all processors each performing steps/operations A-D, and a case in which processor 1 performs step/operation A, processor 2 performs step/operation B and part of step/operation C, and processor 3 performs part of step/operation C and step/operation D), unless otherwise indicated. Further, unless otherwise indicated, statements that one value or action is “based on” another condition or value encompass both instances in which the condition or value is the sole factor and instances in which the condition or value is one factor among a plurality of factors.

Unless the context clearly indicates otherwise, statements that “each” instance of some collection has some property should not be read to exclude cases where some otherwise identical or similar members of a larger collection do not have the property (i.e., each does not necessarily mean each and every). Limitations as to the sequence of recited steps should not be read into the claims unless explicitly specified (e.g., with explicit language like “after performing X, performing Y”) in contrast to statements that might be improperly argued to imply sequence limitations (e.g., “performing X on items, performing Y on the X'ed items”) used for purposes of making claims more readable rather than specifying a sequence. Statements referring to “at least Z of A, B, and C,” and the like (e.g., “at least Z of A, B, or C”), refer to at least Z of the listed categories (A, B, and C) and do not require at least Z units in each category. Unless the context clearly indicates otherwise, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Furthermore, unless indicated otherwise, updating an item may include generating the item or modifying an existing item. Thus, updating a record may include generating a record or modifying the value of an already-generated value in a record. Additionally, as used in the specification, “a portion” refers to a part of, or the entirety of (i.e., the entire portion), a given item (e.g., data) unless the context clearly dictates otherwise.

Unless the context clearly indicates otherwise, ordinal numbers used to denote an item do not define the item's position. For example, an item that may be a first item of a set of items even if the item is not the first item to have been added to the set of items or is otherwise indicated to be listed as the first item of an ordering of the set of items. Thus, for example, if a set of items is sorted in a sequence from “item 1,” “item 2,” and “item 3,” a first item of a set of items may be “item 2” unless otherwise stated.

### Enumerated Embodiments

The present techniques will be better understood with reference to the following enumerated embodiments:
1. A method comprising: determining a first anomalous sequence in a first data stream by using a data quality model; providing the first data stream to a first decision model in lieu of a second decision model based on the first anomalous sequence.
2. A method comprising: determining a first anomalous sequence in a first data stream by using a data quality model; determining a set of patterns based on the first anomalous sequence; determining whether the first anomalous sequence satisfies a set of drift criteria based on the set of patterns; generating a set of synthetic sequences derived from the set of patterns based on a result indicating that the first anomalous sequence satisfies the set of drift criteria; and training the data quality model to obtain an updated data quality model based on the set of synthetic sequences.
3. A method comprising: determining a first anomalous sequence in a first data stream by using a data quality model; determining a set of patterns based on the first anomalous sequence; determining whether the first anomalous sequence satisfies a set of drift criteria based on the set of patterns; generating a set of synthetic sequences derived from the set of patterns based on a result indicating that the first anomalous sequence satisfies the set of drift criteria; and training the second decision model to obtain an updated second decision model based on the set of synthetic sequences.
4. A method comprising: determining a first anomalous sequence in a first data stream by using a data quality model; providing the first data stream to a first decision model in lieu of a second decision model based on the first anomalous sequence; determining a set of patterns based on the first anomalous sequence; determining whether the first anomalous sequence satisfies a set of drift criteria based on the set of patterns and a set of historic patterns; generating a set of synthetic sequences derived from the set of patterns based on a result indicating that the first anomalous sequence satisfies the set of drift criteria; training the data quality model to obtain an updated data quality model based on the set of synthetic sequences; obtaining a second anomalous sequence of a second data stream by providing the second data stream to the updated data quality model to obtain a category for the second anomalous sequence; and providing the second data stream to the second decision model in lieu of the first decision model based on the category for the second anomalous sequence.
5. A method comprising: detecting a first anomalous sequence in a first data stream by using a data quality model to assign a first category to the first anomalous sequence; providing the first data stream to a simpler decision model in lieu of a complex decision model based on the first category, wherein a parameter size of the simpler decision model is less than a parameter size of the complex decision model; determining a set of patterns based on the first anomalous sequence, each respective pattern of the set of patterns characterizing at least a sub-sequence of the first anomalous sequence; determining whether the first anomalous sequence satisfies a set of drift criteria by determining whether any patterns of the set of patterns is unique with respect to a set of historic patterns; synthesizing synthetic sequences based on a determination that the first anomalous sequence satisfies the set of drift criteria; training, based on the synthetic sequences, the data quality model and the complex decision model to obtain an updated data quality model and an updated complex decision model; obtaining a second anomalous sequence of a second data stream by providing the second data stream to the updated data quality model to obtain a second category different from the first category; and providing the second data stream to the updated complex decision model in lieu of the first decision model based on the second category.
6. A method comprising: detecting a first anomalous sequence in a first data stream by using a data quality model; providing the first data stream to a first decision model in lieu of a second decision model based on the first anomalous sequence; determining a set of patterns based on the first anomalous sequence; determining a result indicating that the first anomalous sequence satisfies a set of drift criteria based on the set of patterns and a set of historic patterns; obtaining an updated data quality model and a updated second decision model based on the result by (i) synthesizing a set of synthetic sequences based on the set of patterns and (ii) training the data quality model and the second decision model based on the set of synthetic sequences; obtaining a second anomalous sequence of a second data stream by providing the second data stream to the updated data quality model to obtain a category for the second anomalous sequence; and providing the second data stream to the second decision model in lieu of the first decision model based on the category for the second anomalous sequence.
7. The method of any of the above embodiments, wherein obtaining the updated data quality model comprises: determining a characterizing time associated with the first anomalous sequence, wherein the characterizing time is inclusively between a starting time and an ending time of the first anomalous sequence; determining a duration indicating a time difference between the characterizing time and a time of a most recent training operation for the data quality model; determining a second result indicating that the duration is less than a threshold based on a scheduled training time; and modifying, based on the second result, the scheduled training time to reduce a time until the scheduled training time, wherein training the data quality model or the second decision model comprises training the data quality model or the second decision model at the scheduled training time.
8. The method of any of the above embodiments, wherein the result is a first result, further comprising: determining a second result indicating that the set of patterns comprises at least one unique pattern based on a comparison between the set of patterns and the set of historic patterns; modifying a scheduled training time based on the second result; and retraining the data quality model or the second decision model at the scheduled training time.
9. The method of any of the above embodiments, wherein determining the result comprises: updating an aggregated collection of patterns and a set of pattern counts associated with the aggregated collection of patterns based on the set of patterns by increasing a respective count value of the set of pattern counts associated with each respective pattern of the set of patterns; and determining a set of pattern distribution thresholds based on the set of historic patterns; determining that a pattern distribution fitness threshold is satisfied based on the set of pattern counts.
10. The method of any of the above embodiments, wherein the data quality model comprises a linear transformer model.
11. The method of any of the above embodiments, wherein the data quality model comprises a transformer model, further comprising: determining a throughput of the first data stream; and reducing a window of the transformer model based on the throughput.
12. The method of any of the above embodiments, further comprising: obtaining a set of outcome probabilities using the second decision model; and generating the first decision model by training the first decision model based on the set of outcome probabilities.
13. The method of any of the above embodiments, wherein providing the first data stream to the first decision model comprises selecting the first decision model from a plurality of decision models comprising the first decision model, the second decision model, and a third decision model, wherein a parameter size of the first decision model is less than a parameter size of the second decision model, and wherein the parameter size of the second decision model is less than a parameter size of the third decision model.
14. The method of any of the above embodiments, wherein providing the first data stream to the first decision model comprises: generating a modified data stream by filtering the first anomalous sequence out of the first data stream; and providing the modified data stream to the first decision model.
15. The method of any of the above embodiments, wherein the result is a first result, further comprising: detecting a plurality of anomalous sequences in the second data stream by using the updated data quality model; determining a second result indicating that a count of the plurality of anomalous sequences is greater than an error count threshold; and redirecting additional inputs derived from the second data stream to the first decision model based on the second result.
16. The method of any of the above embodiments, wherein: a plurality of data streams comprises the first data stream; determining the first anomalous sequence comprises determining a plurality of anomalous sequences based on the plurality of data streams; determining the set of patterns comprises determining a plurality of pattern sets based on the plurality of anomalous sequences; and the method further comprise: for each respective count value of a set of pattern counts, increasing the respective count value associated with each respective pattern of the plurality of pattern sets; determining whether the set of pattern counts satisfies a fitness test threshold; and increasing a duration until a next scheduled training time based on a determination that the set of pattern counts satisfies the fitness test threshold.
17. The method of any of the above embodiments, further comprising: obtaining a third anomalous sequence from a third data stream; providing the third anomalous sequence to a sequence generation model to output a corrected event subsequence; generating a corrected sequence by replacing the first anomalous sequence in the first data stream with the corrected event subsequence; and providing the corrected sequence to the second decision model.
18. The method of any of the above embodiments, wherein the set of patterns comprises a plurality of patterns.
19. The method of any of the above embodiments, further comprising detecting an identifier of an entity in the set of patterns, wherein generating the set of synthetic sequences comprises generating at least one event sequence comprising the identifier.
20. The method of any of the above embodiments, wherein the data quality model comprises a transformer model, the method further comprising: determining a message rate of the first data stream; and reducing a window of the transformer model based on the message rate.
21. The method of any of the above embodiments, further comprising chunking the first data stream into a set of chunks, wherein determining the first anomalous sequence comprises providing the set of chunks to the data quality model.
22. The method of any of the above embodiments, wherein training the updated data quality model comprises: determining a duration indicating a time difference between a characterizing time associated with the first anomalous sequence and a time associated with a previous training operation; determining whether the duration is less than a threshold based on a scheduled training time, wherein training the data quality model comprises training the data quality model at the scheduled training time; and modifying the scheduled training time based on a determination that the duration is less than the threshold.
23. The method of any of the above embodiments, further comprising: obtaining a set of outcome probabilities using the second decision model; and generating the first decision model by training the first decision model based on the set of outcome probabilities.
24. A tangible, non-transitory, machine-readable medium storing instructions that, when executed by a data processing apparatus, cause the data processing apparatus to perform operations comprising those of any of embodiments 1-24.
25. A system comprising one or more processors; and memory storing instructions that, when executed by the processors, cause the processors to effectuate operations comprising those of any of embodiments 1-24.
26. A system comprising means for performing any of embodiments 1-24.

What is claimed is:

1. A system for accounting for error drift in a machine learning model by synthesizing event sequences using patterns derived from anomalous sequences to train the machine learning model, the system comprising one or more processors and one or more non-transitory, machine-readable media storing program instructions:
detecting a first anomalous sequence in a first data stream by using a data quality model to assign a first category to the first anomalous sequence;
providing the first data stream to a simpler decision model in lieu of a complex decision model based on the first category, wherein a parameter size of the simpler decision model is less than a parameter size of the complex decision model;
determining a set of patterns based on the first anomalous sequence, each respective pattern of the set of patterns characterizing at least a sub-sequence of the first anomalous sequence;
determining whether the first anomalous sequence satisfies a set of drift criteria by determining whether any patterns of the set of patterns is unique with respect to a set of historic patterns;
synthesizing synthetic sequences based on a determination that the first anomalous sequence satisfies the set of drift criteria;
training, based on the synthetic sequences, the data quality model and the complex decision model to obtain an updated data quality model and an updated complex decision model;
obtaining a second anomalous sequence of a second data stream by providing the second data stream to the updated data quality model to obtain a second category different from the first category; and
providing the second data stream to the updated complex decision model in lieu of the first decision model based on the second category.

2. A method for adapting a machine learning model to error drift, the method comprising:
detecting a first anomalous sequence in a first data stream by using a data quality model;
providing the first data stream to a first decision model in lieu of a second decision model based on the first anomalous sequence;
determining a set of patterns based on the first anomalous sequence;
determining a result indicating that the first anomalous sequence satisfies a set of drift criteria based on the set of patterns and a set of historic patterns;
obtaining an updated data quality model and a updated second decision model based on the result by (i) synthesizing a set of synthetic sequences based on the set of patterns and (ii) training the data quality model and the second decision model based on the set of synthetic sequences;
obtaining a second anomalous sequence of a second data stream by providing the second data stream to the updated data quality model to obtain a category for the second anomalous sequence; and
providing the second data stream to the second decision model in lieu of the first decision model based on the category for the second anomalous sequence.

3. The method of claim 2, wherein obtaining the updated data quality model comprises:
determining a characterizing time associated with the first anomalous sequence, wherein the characterizing time is inclusively between a starting time and an ending time of the first anomalous sequence;
determining a duration indicating a time difference between the characterizing time and a time of a most recent training operation for the data quality model;
determining a second result indicating that the duration is less than a threshold based on a scheduled training time; and
modifying, based on the second result, the scheduled training time to reduce a time until the scheduled training time, wherein training the data quality model or the second decision model comprises training the data quality model or the second decision model at the scheduled training time.

4. The method of claim 2, wherein the result is a first result, further comprising:
determining a second result indicating that the set of patterns comprises at least one unique pattern based on a comparison between the set of patterns and the set of historic patterns;
modifying a scheduled training time based on the second result; and
retraining the data quality model or the second decision model at the scheduled training time.

5. The method of claim 2, wherein determining the result comprises:
updating an aggregated collection of patterns and a set of pattern counts associated with the aggregated collection of patterns based on the set of patterns by increasing a respective count value of the set of pattern counts associated with each respective pattern of the set of patterns; and
determining a set of pattern distribution thresholds based on the set of historic patterns;
determining that a pattern distribution fitness threshold is satisfied based on the set of pattern counts.

6. The method of claim 2, wherein the data quality model comprises a linear transformer model.

7. The method of claim 2, wherein the data quality model comprises a transformer model, further comprising:
determining a throughput of the first data stream; and
reducing a window of the transformer model based on the throughput.

8. The method of claim 2, further comprising:
obtaining a set of outcome probabilities using the second decision model; and
generating the first decision model by training the first decision model based on the set of outcome probabilities.

9. The method of claim 2, wherein providing the first data stream to the first decision model comprises selecting the first decision model from a plurality of decision models comprising the first decision model, the second decision model, and a third decision model, wherein a parameter size of the first decision model is less than a parameter size of the second decision model, and wherein the parameter size of the second decision model is less than a parameter size of the third decision model.

10. The method of claim 2, wherein providing the first data stream to the first decision model comprises:
generating a modified data stream by filtering the first anomalous sequence out of the first data stream; and
providing the modified data stream to the first decision model.

11. The method of claim 2, wherein the result is a first result, further comprising:
detecting a plurality of anomalous sequences in the second data stream by using the updated data quality model;
determining a second result indicating that a count of the plurality of anomalous sequences is greater than an error count threshold; and
redirecting additional inputs derived from the second data stream to the first decision model based on the second result.

12. One or more non-transitory, machine-readable media storing program instructions that, when executed by one or more processors, performs operations comprising:
determining a first anomalous sequence in a first data stream by using a data quality model;
providing the first data stream to a first decision model in lieu of a second decision model based on the first anomalous sequence;
determining a set of patterns based on the first anomalous sequence;
determining whether the first anomalous sequence satisfies a set of drift criteria based on the set of patterns and a set of historic patterns;
generating a set of synthetic sequences derived from the set of patterns based on a result indicating that the first anomalous sequence satisfies the set of drift criteria;
obtaining an updated data quality model based on the set of synthetic sequences and the data quality model;
obtaining a second anomalous sequence of a second data stream by providing the second data stream to the updated data quality model to obtain a category for the second anomalous sequence; and
providing the second data stream to the second decision model in lieu of the first decision model based on the category for the second anomalous sequence.

13. The one or more non-transitory, machine-readable media of claim 12, wherein:
a plurality of data streams comprises the first data stream;
determining the first anomalous sequence comprises determining a plurality of anomalous sequences based on the plurality of data streams;
determining the set of patterns comprises determining a plurality of pattern sets based on the plurality of anomalous sequences; and
the operations further comprise:
for each respective count value of a set of pattern counts, increasing the respective count value associated with each respective pattern of the plurality of pattern sets;
determining whether the set of pattern counts satisfies a fitness test threshold; and
increasing a duration until a next scheduled training time based on a determination that the set of pattern counts satisfies the fitness test threshold.

14. The one or more non-transitory, machine-readable media of claim 12, the operations further comprising:
obtaining a third anomalous sequence from a third data stream;
providing the third anomalous sequence to a sequence generation model to output a corrected event subsequence;
generating a corrected sequence by replacing the first anomalous sequence in the first data stream with the corrected event subsequence; and
providing the corrected sequence to the second decision model.

15. The one or more non-transitory, machine-readable media of claim 12, wherein the set of patterns comprises a plurality of patterns.

16. The one or more non-transitory, machine-readable media of claim 12, the operations further comprising detecting an identifier of an entity in the set of patterns, wherein generating the set of synthetic sequences comprises generating at least one event sequence comprising the identifier.

17. The one or more non-transitory, machine-readable media of claim 12, wherein the data quality model comprises a transformer model, the operations further comprising:
determining a message rate of the first data stream; and
reducing a window of the transformer model based on the message rate.

18. The one or more non-transitory, machine-readable media of claim 12, the operations further comprising chunking the first data stream into a set of chunks, wherein determining the first anomalous sequence comprises providing the set of chunks to the data quality model.

19. The one or more non-transitory, machine-readable media of claim 12, wherein training the updated data quality model comprises:
determining a duration indicating a time difference between a characterizing time associated with the first anomalous sequence and a time associated with a previous training operation;
determining whether the duration is less than a threshold based on a scheduled training time, wherein training the data quality model comprises training the data quality model at the scheduled training time; and
modifying the scheduled training time based on a determination that the duration is less than the threshold.

20. The one or more non-transitory, machine-readable media of claim 12, further comprising:
obtaining a set of outcome probabilities using the second decision model; and
generating the first decision model by training the first decision model based on the set of outcome probabilities.
